(19) United States
(12) Patent Application Publication
(10) Pub. No.: US 2008/0163463 A1
(43) Pub. Date: Jul. 10, 2008

(54) Tool handle

(75) Inventor: Richard M. Hulden, Taylors, SC (US)

Correspondence Address: J. BENNETT MULLINAX, LLC, P. O. BOX 26029, GREENVILLE, SC, 29616-1029, US

(73) Assignee: Sunex International, Inc., Travelers Rest, SC (US)

(21) Appl. No.: 11/651,880

(22) Filed: Jan. 10, 2007

(51) Int. Cl. B25G 1/10

(52) U.S. Cl. 16/430

(57) ABSTRACT

A tool handle for use in a tool such as a screwdriver is provided. The tool handle includes an elongated body that has an axis and a plurality of gripping surfaces that have a planar portion. A stripe is also present that is carried by the body and extends in the axial direction. The stripe is more resilient than the body. A thumb receiving portion is carried by the body and is located proximate to an end of the body. The thumb receiving portion is more resilient than the body.

### FIELD OF THE INVENTION

The present invention relates generally to tool handles used in tools such as screwdrivers, chisels, trowels and scrappers. More particularly, the present application involves a hand tool that includes one or more stripes made of a more resilient material than the body of the tool handle for affording the user an improved grip.

### BACKGROUND

Tools, such as screwdrivers, include tool handles that are configured for being grasped by the hand of a user. A shank of the screwdriver blade is attached to an end of the tool handle. The user can position the tip of the screwdriver blade into a screw to effect insertion or removal by twisting the attached tool handle. Tool handles are advantageously designed in order to prevent slippage and provide comfort to the hand of the user as a significant amount of force, or force over a considerable amount of time, may be applied to the tool handle to effect insertion or removal of a screw.

Tool handles exist that are made of a plastic body with a generally circular cross-section. Although these types of handles afford a comfortable feel to the user when grasping the handle, they are problematic in that the handle may slip from the grip of the user when applying a strong twisting force thereto in order to loosen or tighten a screw. It is therefore the case that slip resistant coatings are applied to strategic locations on the plastic body in order to inhibit slippage. The slip resistant coatings are made of a softer material than the plastic body in order to allow portions of the user's hands to press therein and create resistance to slipping when turning the tool handle. Such dual durometer tool handles are known in the art and can be manufactured by molding the softer slip resistant coatings into recesses present in the plastic body. Alternatively, the slip resistant coatings may be attached to the plastic body at other locations through any commonly known means. For example, the slip resistant coatings can be adhered or mechanically fastened to the plastic body.

It is also known to make tool handles that have a substantially square shaped cross-section. Tool handles in this configuration are advantageous in that they have several flat surfaces that receive the hand of the user in such a manner that the occurrence of slippage is reduced. However, the edges of the square shaped cross-section of the plastic body may be problematic. In this regard, the edges tend to cut into the hand of the user during grasping and turning of the tool handle. This is especially true when a significant amount of force is applied to the tool handle. The user may have to reduce the amount of force applied to the tool handle in order to lessen the impact of the edges cutting into the user's hand. Alternatively, the user may continue to apply a significant amount of force to the tool handle which results in discomfort to the user as the edges cut into his or her hand.

It is known to provide softer portions onto the hard plastic body of tool handles with substantially square shaped cross-sections. The present invention improves upon previous and current tool handles by providing for a tool handle that is made of portions that have different resiliencies. The tool handle can be configured so that slippage is reduced and comfort is increased during use of the tool handle.

### SUMMARY

Various features and advantages of the invention will be set forth in part in the following description, or may be obvious from the description, or may be learned from practice of the invention.

The present invention provides in one aspect for a tool handle that has an elongated body with an axis and a plurality of gripping surfaces that have a planar portion. A stripe is included that extends in the axial direction and is carried by the body. The stripe is more resilient than the body. A thumb receiving portion is present and is carried by the body and located proximate to an end of the body. The thumb receiving portion is more resilient than the body.

Another aspect of the present invention exists in a tool handle as immediately discussed in which four stripes and four gripping surfaces are present. Each of the gripping surfaces has a planar portion. The stripes and the planar portions define a perimeter so that each of the stripes is located between a pair of the planar portions with respect to the perimeter defined by the planar portions and the stripes.

A further aspect of the present invention resides in a tool handle as discussed above in which the body is injection molded.

An additional aspect of the present invention is provided in a tool handle that has an injection molded elongated body with an axis and a plurality of gripping surfaces. The gripping surfaces have planar portions that are configured for being contacted by the hand of a user. The body defines a recess for receiving a tool element. A stripe extends in the axial direction and is carried by the body and is more resilient than the body.

Another exemplary embodiment of the present invention exists in a tool handle as previously discussed in which the stripe is injection molded. Further, an injection molded thumb receiving portion is included and is carried by the body. The thumb receiving portion is located proximate to an end of the body, and the thumb receiving portion is more resilient than the body.

A further exemplary embodiment of the present invention is found in a tool handle as immediately discussed in which four stripes and four gripping surfaces are present. Each of the gripping surfaces has a planar portion. The stripes and the planar portions define a perimeter so that each of the stripes is located between a pair of the planar portions with respect to the perimeter defined by the planar portions and the stripe. Four thumb receiving portions are present and are arranged so that each one of the gripping surfaces carries one of the thumb receiving portions.

An additional aspect of the present invention exits in a tool handle as immediately discussed in which successive planar portions about the perimeter defined by the planar portions and the stripes are oriented at a ninety degree angle to one another. Further, the body is made of polyethylene or polypropylene, and the stripes and thumb receiving portions are made of thermoplastic rubber.

Another aspect of the present invention resides in a tool handle as discussed above in which the stripe and a pair of the gripping surfaces define a perimeter so that the stripe is located between the pair of gripping surfaces with respect to the perimeter defined by the stripe and the pair of gripping surfaces.

An additional aspect of the present invention exits in a tool handle as previously mentioned in which the stripe and the thumb receiving portion are injection molded. The body, stripe and thumb receiving portion are formed by a two step injection molded process.

An exemplary embodiment of the present invention resides in a tool handle as previously mentioned in which the body defines a recess. A screwdriver blade is also included that has an elongated shank. The elongated shank is located in the recess so that the screwdriver blade is carried by the body.

An additional aspect of the present invention exists in a tool handle as described above in which the height of the outer surface of the stripe to the axis is the same or less than the height of the planar surface to the axis.

The present invention provides for a tool handle, in one aspect, that has an injection molded elongated body. The body has four gripping surfaces that each have a planar portion that are arranged so that the body has a substantially square shaped cross-section with edges that define recesses. Four injection molded stripes are disposed in the recesses of the body and are carried by the body. The stripes extend in the axial direction and are more resilient than the body. The surfaces of the planar portions are located at the same or greater distance from the center of the body than the outer surfaces of adjacent stripes. Four injection molded thumb receiving portions are also present. Each of the thumb receiving portions is carried by one of the gripping surfaces and is located proximate to an end of the body. The thumb receiving portions are more resilient than the body.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of a tool handle in accordance with one exemplary embodiment of the present invention.

FIG. 2 is a plan view of the tool handle of FIG. 1.

FIG. 3 is a cross-sectional view taken along line 3-3 of FIG. 1.

FIG. 4 is a perspective view of the tool handle of FIG. 1 with the shank of a screwdriver blade attached thereto.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a tool handle 10 that can be used in tools such as screwdrivers. The tool handle 10 can have a generally square cross-sectional shape that has edges made of stripes 22. The stripes 22 are made of a material that has greater resiliency than the material making up the body 12 of the tool handle 10. Such a configuration helps minimize forces imparted onto the hand of the user when grasping and/or turning the tool handle 10. Thumb receiving portions 24, which are more resilient than the material making up the body 12, are also provided and help minimize forces imparted to the thumb and/or index finger of the user when using the tool handle 10.

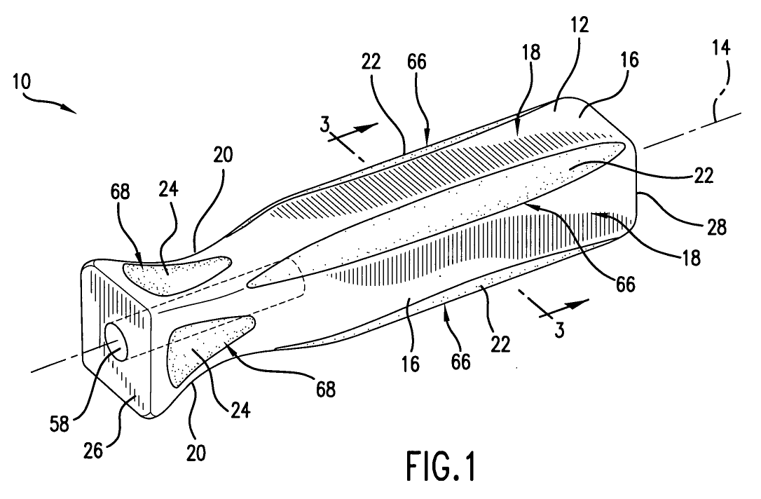

FIG. 1 shows a tool handle 10 in accordance with one exemplary embodiment of the present invention. The tool handle 10 includes an elongated body 12 that can be made of a variety of materials. For example, the body 12 can be made of polyethylene, polypropylene, polyurethane, metal or nylon in accordance with various exemplary embodiments. The body 12 can be formed as one piece or may be composed of multiple pieces that are then assembled with one another. Various processes may be used in order to construct the body 12. For example, the body 12 is formed by injection molding in accordance with one embodiment. Alternatively, the body 12 can be formed by casting or extrusion.

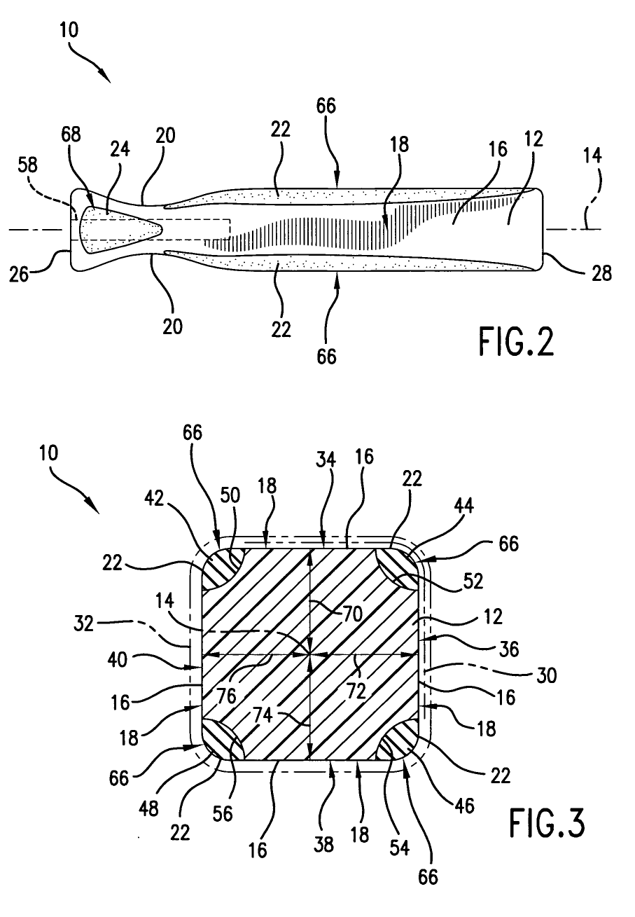

The body 12 has a plurality of gripping surfaces 16 configured symmetrically about an axis 14. Although four gripping surfaces 16 are shown in the exemplary embodiment described with respect to FIGS. 1-3, it is to be understood that any number of gripping surfaces 16 may be employed in other embodiments. For example, from three to eight gripping surfaces 16 may be present in other embodiments. Each of the gripping surfaces 16 has a planar portion 18. The planar portions 18 are elongated and extend in the axial direction. The planar portions 18 may be sized so that they extend up to 75% of the length of the gripping surfaces 16 in the axial direction. The planar portions 18 have a generally smooth and consistent upper surface. However, in other embodiments, the planar portions 18 may have holes or other recesses defined thereon. As such, the planar portions 18 need not be perfectly smooth and flat surfaces in other embodiments but may have projections, recesses or irregularities defined thereon. Further, all of the planar portions 18 may be configured identically or may be provided so as to be different from one another in accordance with different embodiments of the invention.

The planar portions 18 are located adjacent an end 28 of body 12. As shown, body 12 is rounded in the transition between the planar portions 18 and the end 28 in order to eliminate sharp edges that may be formed so as to reduce or minimize the occurrence of sharp edges that may tend to bite into the hand of the user when manipulating the tool handle 16. The gripping surface 16 may also have a concave portion 20 defined thereon and located next to the planar portion 18 in the axial direction. The concave portion 20 extends from the planar portion 18 so as to be closer to the axis 14. The concave portion 20 then extends away from the axis 14 towards an end 26 of the body 12. The concave portions 20 can have a generally smooth and flat upper surface, like the planar portions 18, or may have an upper surface that defines recesses, projections or irregularities. All of the concave portions 20 of the body 12 can be identical to one another. In other embodiments, the surface and shape of the concave portions 20 may be different from one another. Although shown as having but a single planar portion 18 and concave portion 20, the gripping surface 16 can have any number of portions 18 or 20 in accordance with other embodiments. Further, the gripping surface 16 need not have a concave portion 20. In these instances, the planar portion 18 can extend all the way to the end 26, or the planar portion 18 can extend to a convex or differently shaped portion of body 12.

A plurality of stripes 22 are present on the body 12 in order to provide an improved grip for the user of the tool handle 10. The user will grasp the tool handle 10 so that the palm and fingers of his or her hand wrap around the planar portions 18 of the gripping surfaces 16. The stripes 22 are located intermittent adjacent planar portions 18 so as to be located at essentially the edges of the body 12. The stripes 22 are made of a material so as to be more resilient than the planar portions 18. In several different embodiments, the stripes 22 are made of thermoplastic rubber. Other embodiments exist in which the stripes 22 can be made of polyethylene, polypropylene, polyurethane, nylon or vinyl. The stripes 22 act to give cushioning to the palm and fingers of the user's hand when grasping the tool handle 10 as the harder, potentially sharp edges formed between the meeting of adjacent planar portions 18 are not present. The stripes 22 function to minimize force that tends to cut into the user's hand while at the same time allowing forces generated by the user to be transferred into the body 12. The body 12 may have a hardness value that is two to six times harder than the stripes 22. The stripes 22 can be completely elastic so as to resume their original shape upon the removal of force applied by the hand of the user. Alternatively, the stripes 22 can be only partially or non-elastic so that they do not completely return to their pre-stressed shape.

The embodiment in FIGS. 1-3 has a stripe 22 present between all adjacent planar portions 18. In other embodiments, stripes 22 can be present between select planar portions 18 and need not be provided between all of the planar portions 18. The stripes 22 extend in the axial direction of the tool handle 10 and extend beyond the axial length of the planar portions 18. As shown, the stripes 22 extend in the axial direction so at to be located between adjacent concave portions 20 along at least part of the axial length of the concave portions 20. The ends of the stripes 22 are tapered, although they may end abruptly so as to form a sharp edge in other embodiments. The stripes 22 are shown as extending across and beyond the entire axial length of the planar portion 18. However, in other embodiments the stripes 22 can extend across only part of the axial length of the planar portions 18. For example, the stripes 22 can extend across from 25% to 75% of the axial length of the planar portions 18 in other exemplary embodiments. Additionally, the stripes 22 can extend in the axial direction beyond the planar portions 18 to the end 28 of the body 12.

As shown in FIG. 1, the stripes 22 extend past the planar portions 18 in the axial direction and terminate in the transition between the planar portions 18 and the end 28. The outer surface 66 of the stripe 22 can be convex in shape to provide a smoother transition between adjacent planar portions 18 when grasping the tool handle 10. The outer surface 66 can also have a convex section and planar sections that are adjacent the planar portions 18 in other embodiments. Still further, the outer surface 66 may include planar sections that contact one another so as to form a sharp edge. Although this sharp edge may bite into the hand of the user when grasping the tool handle 10, as would a similar sharp edge on body 12, the effect would not be as strong since the strip 22 is made of a material that is more resilient than the body 12.

A plurality of thumb receiving portions 24 are also included in the tool handle 10 and are carried by the body 12. Each one of the thumb receiving portions 24 is located on a separate concave portion 20 of a gripping surface 16. As with the stripes 22, the thumb receiving portions 24 are more resilient than the body 12. The thumb receiving portions 24 can be made out of a variety of materials. For example, the thumb receiving portions 24 are made of thermoplastic rubber in various exemplary embodiments. Other embodiments exist in which the thumb receiving portions 24 are made of polyethylene, polypropylene, polyurethane, nylon or vinyl. As with the stripes 22, the thumb receiving portions 24 can be completely elastic, partially elastic, or non-elastic. As shown, portions 24 have a generally triangular shape with rounded corners. The body 12 can also have a hardness that is from two to six times that of the thumb receiving portions 24. All of the portions 24 of the tool handle 10 can be designed similar to one another or may be made of different materials and have different shapes. Although the thumb receiving portions 24 can be made of different materials and through a different manufacturing process than the stripes 22, in certain embodiments these elements can be made from the same material and made by the same process for sake of convenience. For example, all of the stripes 22 and thumb receiving portions 24 are made of thermoplastic rubber and are formed by an injection molding process in accordance with certain exemplary embodiments.

Upon gripping the tool handle 10, the thumb of the user is located against one of the concave portions 20 of the body 12 while the palm and fingers of the user are located against the planar portions 18 and stripes 22. The concave portion 20 is also shaped in such a manner so as to receive the thumb of the user upon conventional grasping of the tool handle 10. The thumb of the user is pressed against the thumb receiving portion 24 which acts to cushion the forces imparted back onto the thumb due to its resiliency. As shown, the outer surface 68 of the thumb receiving portion 24 is concave in shape. The outer surface 68 may be shaped so as to match the contour of the outer surface of the concave portion 20. Alternatively, the outer surface 68 can be located above the proximate portions of the outer surface of the concave portion 20 so that the presence of the thumb receiving portion 24 is more noticeable to the user of the tool handle. The outer surface 68 can be smooth or may have projections, recesses or irregularities defined thereon. Further, the configuration of the outer surface 68 may be the same for all of the thumb receiving portions 24 of the tool handle 10 or may be different from one thumb receiving portion 24 to the next.

As the portion 24 is more resilient than the body 12, pressure imparted back onto the thumb through use of the tool handle 10 is reduced as compared to the configuration in which the portion 24 is absent. Although shown as having a thumb receiving portion 24 on each one of the concave portions 20, other embodiments exist in which the thumb receiving portion 24 is absent on one or more of the concave portions 20. Further embodiments exist in which thumb receiving portions 24 are not included in the tool handle 10.

The tool handle 10 can be produced by a two time injection molding process. Here, the body 12 can be formed by an injection molding process. The stripes 22 and thumb receiving portions 24 can then be formed by another injection molding process with a material that has a greater resiliency than that of the material forming the body 12. Although described as being made through the use of injection molding, it is to be understood that other methods of manufacturing the tool handle 10, such as casting, may be employed. The stripes 22 and thumb receiving portions 24 can be injection molded directly into the recesses 50, 52, 54 and 56, or these portions may be formed separately and then attached to the body 12. The stripes 22 and thumb receiving portions 24 can be held onto the body 12 through any means known in the art. For example, these components can be held through adhesion, mechanical fasteners, or may be welded onto the body 12. The body 12 is harder than the stripes 22 and the thumb receiving portions 24 so that the durometer value of the body 12 is greater than stripes 22 and thumb receiving portions 24. The body 12 may have a Shore D hardness from 41 to 60, and the stripes 22 and thumb receiving portions 24 may have a Shore A hardness from 5 to 40. Alternatively, the stripes 22 and thumb receiving portions 24 may have a Shore A hardness from 40 to 80.

FIG. 3 is a cross-sectional view taken along line 3-3 of FIG. 1. Here, the body 12 of the tool handle 10 is shown to have a substantially square shaped cross-section. Planar portions 18 are identified more specifically as planar portions 34, 36, 38 and 40 for sake of discussion. A set of recesses 50, 52, 54 and 56 are defined between successive planar portions 34, 36, 38 and 40. The recesses 50, 52, 54 and 56 have generally concave outer surfaces that are consistent and extend across the entire axial length of the planar portions 34, 36, 38 and 40. The cross-sectional shape of recesses 50, 52, 54 and 56 vary in the axial direction at the concave portions 20 and also proximate to the end 28.

A plurality of stripes 22 are disposed into the recesses 50, 52, 54 and 56. Stripes 22 are designated more specifically by reference numbers 42, 44, 46 and 48 in FIG. 3. As shown, stripe 42 is disposed in recess 50 while stripe 44 is disposed in recess 52. Similarly, stripe 46 is located in recess 54 and stripe 48 is located in recess 56. The planar portions 34 and 36 in addition to the outer surface 66 of stripe 44 define a perimeter 30. Stripe 44 is located between planar portions 34 and 36 with respect to the perimeter 30 defined by these components. In similar manners, the other planar portions 34, 36, 38 and 40 and stripes 42, 44, 46, and 48 define similar perimeters so that the stripes 42, 44, 46 and 48 are located between adjacent planar portions 34, 36, 38 and 40 with respect to their defined perimeters. All of these components likewise define a perimeter 32 that extends around all four of the stripes 42, 44, 46 and 48 and planar portions 34, 36, 38 and 40. The aforementioned components are arranged so that each of the stripes 42, 44, 46 and 48 are located between successive planar portions 34, 36, 38 and 40 about the perimeter 32.

The stripes 22 can be configured so that their outer surfaces 66 are flush with the planar portions 18. FIG. 3 shows the planar portion 34 having a height 70 from the axis 14. Likewise, planar portion 36 is located a height 72 from the axis 14, and planar portion 38 is located a height 74 from axis 14. Finally, planar portion 40 is located at a height 76 from the axis 14. The outer surface 66 of stripe 42 has a maximum point that is the same as height 70 of planar portion 34 and height 76 of planar portion 40. As such, the outer surface 66 of stripe 42 does not extend past heights 70 and 76 of planar portions 34 and 40 so that the stripe 42 is essentially flush with portions 34 and 40. In a similar manner, stripe 44 has an outer surface 66 that has a maximum point that equals height 70 of planar portion 34 and height 72 of planar portion 36. Again, the outer surface 66 of stripe 44 is flush with the planar portions 34 and 36. Stripes 46 and 48 are arranged in a similar manner. The outer surface 66 of stripe 46 has a maximum point that is located at the height 72 of planar portion 36 and at height 74 of planar portion 38. The maximum point of the outer surface 66 of stripe 48 is located at the height 74 of planar portion 38 and at height 76 of planar portion 40.

Although described as being located at the heights 70, 72, 74 and 76 of the planar portions 18, the maximum point of the stripes 22 can be located below the aforementioned heights 70, 72, 74 and 76. For example, stripe 42 can have an outer surface 66 with a maximum height that is less than that of the height 70 of the planar portion 34. Further, the maximum height of the outer surface 66 of stripe 42 may or may not be less than the height 76 of planar portion 40. The other stripes 44, 46 and 48 may or may not be provided in a similar manner. The stripes 22 can be either initially provided in such a manner or may become depressed deeper into the recesses 50, 52, 54 and 56 upon the application of force in instances in which the stripes 22 are not completely elastic. Although described as being flush with or depressed from the planar portions 18, the stripes 22 can be located above the planar portions 18 in accordance with other exemplary embodiments of the present invention. For example, the maximum height of the outer surface 66 of stripe 42 is above or greater than height 70 of planar portion 34 in one embodiment.

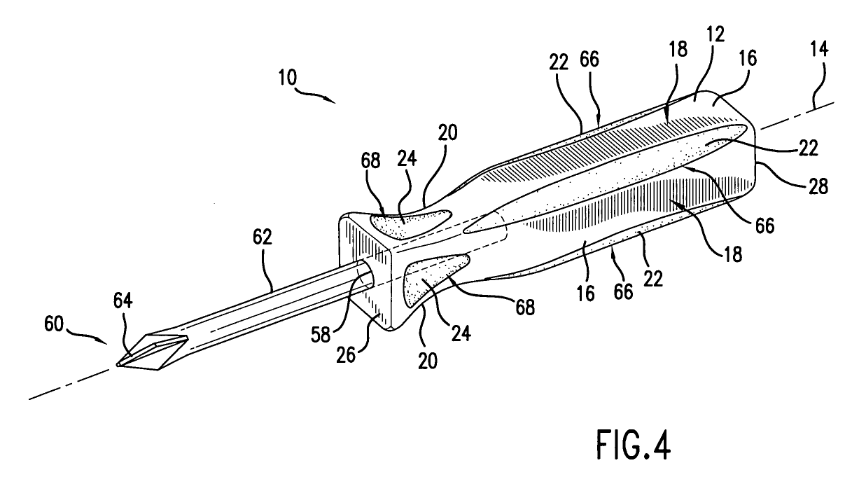

FIG. 4 shows another alternative exemplary embodiment of the present invention. A recess 58 is defined in the body 12 and has an opening on end 26. A shank 62 of a screwdriver blade 60 is disposed within recess 58 and is attached to the body 12 through any means commonly known in the art. The screwdriver blade 60 is provided with a tip 64 on one end that is commonly known as a Phillips head tip. It is to be understood that the tip 64 need not be a Phillips head tip but can be a flat head in other embodiments. Although shown in conjunction with a screwdriver, the tool handle 10 can be used in a variety of tools such as chisels, trowels and scrappers. Here, the tool element can be inserted into and retained within the recess 58.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A tool handle, comprising:
an elongated body having an axis and a plurality of gripping surfaces with a planar portion;
a stripe extending in the axial direction and carried by said body, wherein said stripe is more resilient than said body; and
a thumb receiving portion carried by said body and located proximate to an end of said body, wherein said thumb receiving portion is more resilient than said body.

2. The tool handle as in claim 1, wherein said stripe and a pair of said gripping surfaces define a perimeter such that said stripe is located between said pair of gripping surfaces with respect to the perimeter defined by said stripe and said pair of gripping surfaces.

3. The tool handle as in claim 1, wherein four stripes and four gripping surfaces are present, and wherein each of said gripping surfaces has a planar portion, and wherein said stripes and said planar portions define a perimeter such that each of said stripes is located between a pair of said planar portions with respect to the perimeter defined by said planar portions and said stripes.

4. The tool handle as in claim 3, wherein four thumb receiving portions are present such that each one of said gripping surfaces carries one of said thumb receiving portions.

5. The tool handle as in claim 4, wherein successive said planar portions about the perimeter defined by said planar portions and said stripes are oriented at a ninety degree angle to one another, and wherein said body is made of polyethylene or polypropylene, and wherein said stripes and said thumb receiving portions are made of thermoplastic rubber.

6. The tool handle as in claim 1, wherein said body is injection molded.

7. The tool handle as in claim 6, wherein said stripe and said thumb receiving portion are injection molded such that said body, said stripe and said thumb receiving portion are formed by a two step injection molded process.

8. The tool handle as in claim 1, wherein said body defines a recess, and further comprising a screwdriver blade having an elongated shank, and wherein said elongated shank is located in said recess such that said screwdriver blade is carried by said body.

9. The tool handle as in claim 1, wherein said stripe has an outer surface that is convex in shape, and wherein said thumb receiving portion has an outer surface that is concave in shape.

10. The tool handle as in claim 1, wherein the height of the outer surface of said stripe to said axis is the same or less than the height of said planar surface to said axis.

11. A tool handle, comprising:
an injection molded elongated body having an axis and a plurality of gripping surfaces with a planar portion configured for being contacted by the hand of a user, wherein said body defines a recess for receiving a tool element; and
a stripe extending in the axial direction and carried by said body, wherein said stripe is more resilient than said body.

12. The tool handle as in claim 11, wherein said stripe is injection molded, and further comprising an injection molded thumb receiving portion carried by said body and located proximate to an end of said body, wherein said thumb receiving portion is more resilient than said body.

13. The tool handle as in claim 12, wherein said body, said stripe and said thumb receiving portion are formed by a two step injection molded process.

14. The tool handle as in claim 12, wherein said stripe has an outer surface that is convex in shape, and wherein said thumb receiving portion has an outer surface that is concave in shape.

15. The tool handle as in claim 12, wherein four stripes and four gripping surfaces are present, and wherein each of said gripping surfaces has a planar portion, and wherein said stripes and said planar portions define a perimeter such that each of said stripes is located between a pair of said planar portions with respect to the perimeter defined by said planar portions and said stripe, and wherein four thumb receiving portions are present such that each one of said gripping surfaces carries one of said thumb receiving portions.

16. The tool handle as in claim 15, wherein successive said planar portions about the perimeter defined by said planar portions and said stripes are oriented at a ninety degree angle to one another, and wherein said body is made of polyethylene or polypropylene, and wherein said stripes and said thumb receiving portions are made of thermoplastic rubber.

17. The tool handle as in claim 11, wherein said body defines a recess, and further comprising a screwdriver blade having an elongated shank, and wherein said elongated shank is located in said recess such that said screwdriver blade is carried by said body.

18. The tool handle as in claim 11, wherein the height of the outer surface of said stripe to said axis is the same or less than the height of said planar surface to said axis.

19. The tool handle as in claim 11, wherein said stripe and a pair of said gripping surfaces define a perimeter such that said stripe is located between said pair of gripping surfaces with respect to the perimeter defined by said stripe and said pair of gripping surfaces.

20. A tool handle, comprising:
an injection molded elongated body having four gripping surfaces that each have a planar portion that are arranged so that said body has a substantially square shaped cross-section with edges that define recesses;
four injection molded stripes disposed in said recesses of said body and carried by said body, said stripes extending in the axial direction, wherein said stripes are more resilient than said body, wherein the surfaces of said planar portions are located at the same or greater distance from the center of said body than the outer surfaces of adjacent said stripes; and
four injection molded thumb receiving portions, wherein each one of said thumb receiving portions is carried by one of said gripping surfaces and is located proximate to an end of said body, wherein said thumb receiving portions are more resilient than said body.
